(19) United States
(12) Patent Application Publication
(10) Pub. No.: US 2014/0182520 A1
(43) Pub. Date: Jul. 3, 2014

(54) HARNESS FOR PETS

(71) Applicant: Mariana Goluboff, Buenos Aires (AR)

(72) Inventor: Mariana Goluboff, Buenos Aires (AR)

(21) Appl. No.: 14/107,114

(22) Filed: Dec. 16, 2013

(30) Foreign Application Priority Data
Dec. 27, 2012 (AR) 20120105023

(51) Int. Cl. A01K 27/00

(52) U.S. Cl. CPC A01K 27/002
USPC 119/863; 119/856

(57) ABSTRACT

A harness for pets that allows them to move freely, without causing them damage or possible wounds, thanks to a piece of laminar textile material composed of a central part with front vertexes and rear vertexes which project themselves to define both ears with complementary connection clasps, and both parts of belt with complementary fasteners, and the central part shows an opening on one of the sides of the center of the part, while on the other side there is a girdle with fasteners for a leash.

### FIELD OF THE INVENTION

This invention is related to the field of complements for pet care such as dogs and cats, and it especially refers to a harness for pets that guarantees an effective fastening of the pet without causing body damage or muscle discomfort or pain in the animal.

### BACKGROUND ART

The walking leashes and collars, as well as the harnesses made of a set of leashes are well known in the business of pet care and possession. So, those harnesses that are made of a band that fastens the body of the animal, a dog, for example, by taking it from its neck, under the arms or legs and around its elbows are well known. In another embodiment, the bands are passed to fasten the animal from its cross or back, abdomen and chest, in which said harness is provided with a buckle or ring that allows the leash to be tied. Said harnesses with bands are adjustable, i.e., they may be adjusted to the size of each kind of animal; they are usually light and especially cheap, so that any person may buy them. However, as they are made of thin bands, these bands have a very small contact surface with the animal, and because of the material they are made of, they cause wounds in the fur, the armhole and especially, they damage the back, since said harness with a band is neither anatomical nor ergonomic.

Another well-known embodiment is the “hybrid”-type harness, which has a front combined with the bands of the kind described in the previous embodiment. In this kind of harness, the front is placed on the animal's chest, and the bands are fastened and passed round the neck and chest. The hybrid harness is also adjustable and light. However, its cost is higher than that of the harness with a band, and like the latter, it has a small contact surface, and because of the material it is made of, it causes damage to the animal's fur, hurting the armhole and causing wounds in its back because it is not anatomical.

In another embodiment, the harness is composed of a front with an upper and a lower part, where the lower part is placed on the pet's chest, while the upper part leans against the back of the animal, and both the upper and the lower part are connected by means of portions that extend and cover part of the back and the chest. In this way, by having a front, the harness has a bigger contact surface, and at the same time, it is light and adjustable. However, even if it provides a bigger contact surface, there are a number of inconveniences, for example, the lack of flexibility of the front which limits the movements performed by the animal every day. In which, said upper part of the front, mostly covers the whole of the animal's back, and therefore, it is not a very anatomical model, that finally ends up hurting the animal's back.

Summarizing, the conventional harnesses show a number of inconveniences that damage the pet's health, particularly when the owner of the pet pulls the harness and this action hurts any part of the animal, which may be the armhole, the back, the chest or the legs. Likewise, the design they show is hardly favorable for the pets, since they either hurt their fur and health, or do not allow pets to move freely according to their needs.

Considering the present state of the technique available for harnesses for pets, and with the purpose of avoiding pain or discomfort and possible body damage in the animals, as it was described above, it would be very convenient to have a new harness for pets, which is made to solve the inconveniences of the conventional harnesses.

### BRIEF DESCRIPTION OF THE INVENTION

Therefore, it is one of the purposes of this invention to provide a new harness for pets, made to avoid discomfort or possible body damage in animals by eliminating the inconveniences caused by conventional harnesses.

Another objective of this invention is to provide an anatomical harness for pets that gives them more freedom in their movements, without hurting their back, armhole and legs.

Another objective of this invention is to provide a harness for pets that are overweight or have back problems which prevents them from making big movements when they raise their legs.

Another objective of this invention is to provide a harness for pets that is made to cushion satisfactorily the effects provoked by the forces applied when the owner of the pet pulls the leash.

Another objective of this invention is to provide a harness for pets made of a piece of laminar textile material composed in general by a central part with front vertexes and rear vertexes and the relevant ears with complementary connection clasps project themselves from said front vertexes and the relevant parts of belt with complementary fastening methods also project themselves from these front vertexes, and said central part shows an opening laid out on one side of the center of said part while a girdle with the fastening for a leash is laid out on the opposite side.

### BRIEF DESCRIPTION OF THE DRAWINGS

To clarify and understand better the purpose of this invention, it has been illustrated with several figures, in which this invention has been represented in one of the preferred embodiments, all of which is to be considered just an example, in which:

FIG. 1 shows the harness of the invention unfolded and seen from its outer surface, i.e., that one which is not against the animal's body.

FIG. 2 shows the harness in FIG. 1 in an intermediate folding stage round the body of the animal that is not shown.

FIG. 3 shows the harness of the invention totally closed and seen from the back of the animal, and

FIG. 4 show the harness of the invention totally closed and seen from the thorax of the animal.

### DETAILED DESCRIPTION OF THE INVENTION

Referring to the figures, we can see that the invention consists of a harness for pets that has been designed to save the inconveniences caused by conventional harnesses as regards the discomfort and possible wounds and/or damage they cause to pets, particulary, on the back, armhole, legs, chest, etc. Likewise, the design of the harness of this invention allows the animal to move its head and legs freely, softening the forces applied when the leash is pulled.

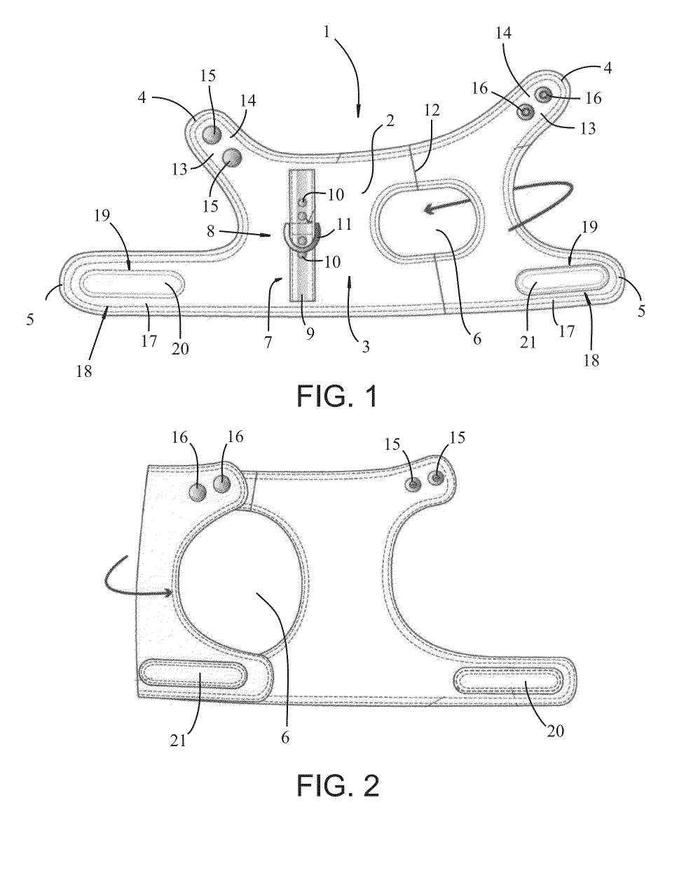

Referring to FIGS. 1 to 4, we can see a harness for pets showed by the general reference 1. Said harness 1 is made of a piece of laminar textile material composed of a central part 3 that shows front vertexes 4 and rear vertexes 5. In which, said central part 3 is preferable quadrangular and shows an oblong opening 6 laid out on one side of the center of said part 3 while a girdle 7 is laid out on the opposite side with fastening methods 8 for a leash. Said girdle 7 shows a central line 9 composed of a reflective band which extends lengthwise, and said girdle 7 is on an intermediate part, with several fastening clasps 10 that link said girdle 7 with the central part 3, with a seam which joins both parts. The fastening means 8 for a leash are laid out in said intermediate part of the girdle 7 and are composed of a buckle 11 of the half-round kind. Likewise, in said central part 3 there is a linking crossing line 12 between the thorax and the back of the pet.

On the other hand, the front vertexes 4 are laid out in both ears 13 that bear complementary connection clasps 14, with male clasps 15 and female clasps 16. This does not mean that the invention is limited to having clasps of the same kind in one ear, but that the combination of at least one male clasp with at least one female clasp laid out in the same ear may also be considered. The complementary connection clasps 14 may be of the nickel plated type or black, and the quantity in stock shall depend on the size of the animal, i.e., on the size used, which means that there may be a variation between one to three clasps laid out in each ear 13. Likewise, the parts of the belt 17 are laid out from said rear vertexes 5 with complementary fasteners 18 composed of “Velcro”®-type fortified material clasps 19, which resists the force caused by the action of pulling the leash, and they are defined as male clasp 20 and female clasp 21.

As regards the material of the laminar piece 2, its outer side is composed of a 3D Aired Mesh known in the market as “3D Air Mesh”, whereas its inner side is made of synthetic fibers such as elastane, known in the market as “Lycra”®. In this way, the pet manages to release the perspiration satisfactorily, and move; and thanks to the capacity of the material to stretch, the air mesh lets absorbs the pulling force. At the same time, the laminar piece 2 is lined and may show in a part the label of the marketing company and the recommendations for washing, where it has been manufactured, etc. In a discontinuous line the figure shows the backstitches or seam in the fabric to join the linen with the outer and inner materials, and the color of the backstitching is similar to that of the linen.

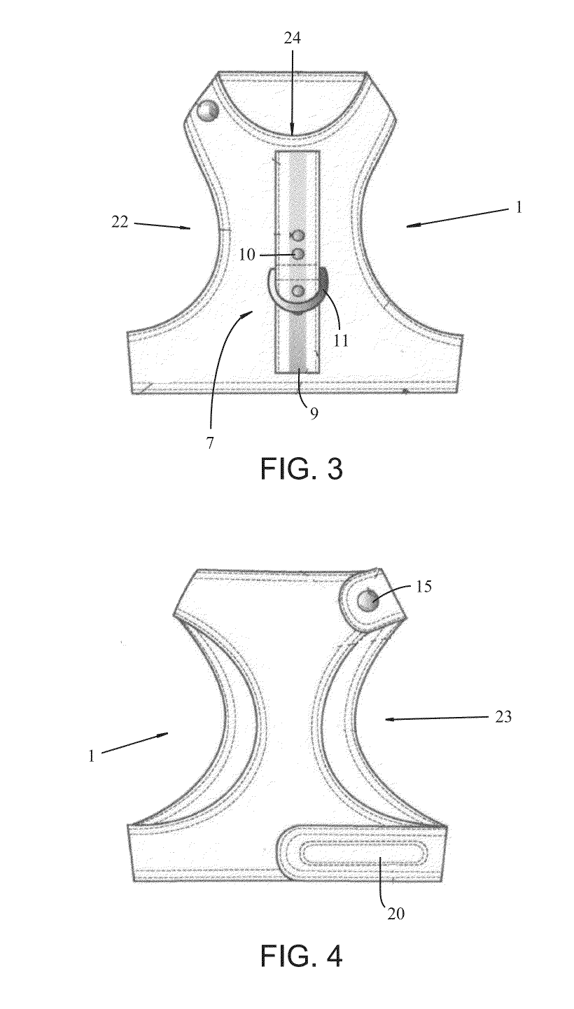

Referring to FIGS. 3 and 4 we can see the harness for pets 1 of this invention, already assembled. For such a purpose, the relevant parts should be folded as it is indicated with the arrows, and therefore forming the model in the figure. In this way, two parts are defined, an upper part 22 and a lower part 23, and the upper part 22 is placed with the girdle 7, on the back of the pet, while the lower part 23 is on the pet's chest. In FIG. 3, there is an armhole, and a low-cut neck 24 that allows the free movement of the head and legs of the pet.

In this way, the harness for pets of this invention is formed and made to save the inconveniences caused by conventional harnesses as regards the wounds and possible damage they cause to pets. Wherein, the material of the laminar piece 2 of the harness of this invention allows the exact stretching without losing the shape, softening the forces caused by the owner when he/she pulls the leash.

In turn, the correct location of the buckle 11 prevents the owner from hurting the pet when he/she pulls the leash. Besides, as it is an anatomical and ergonomic model, it suitably accompanies the amplitude of the movements, without hurting the pet, and the contact surface of the garment with the dog is minimum, but enough to guarantee the integrity and functionality of the harness.

Having especially described and determined the nature of this invention and the way in which it should be put into practice, we do hereby claim the ownership and exclusive right of:

What is claimed is:

1. A harness for pets comprising:
a piece of a laminar textile material including a central part with front vertexes and rear vertexes, which project to define ears with complementary connection clasps,
wherein the rear vertexes includes complementary parts of a belt with fasteners; and
the central part includes an opening on a first side and a girdle with fasteners on a second side, the girdle is adapted to be connected to a leash.

2. The harness according to claim 1, wherein the central part includes a general quadrangular configuration.

3. The harness according to claim 1, wherein said opening has an oblong form.

4. The harness according to claim 1, wherein said fasteners for a leash include a buckle.

5. The harness according to claim 4, wherein said buckle is half round.

6. The harness according to claim 1, wherein said complementary connection clasps are at least between one and three.

7. The harness according to claim 6, wherein said connection clasps are between one and three.

8. The harness according to claim 1, wherein said complementary fasteners of the rear vertexes include a “Velcro”-type set.

9. The harness according to claim 1, wherein the outer material of said laminar textile piece is a 3D air mesh, whereas the inner one is made of synthetic fiber.

10. The harness according to claim 9, wherein said laminar textile piece has a linen.
